(19) United States
(12) Patent Application Publication
(10) Pub. No.: US 2024/0163234 A1
(43) Pub. Date: May 16, 2024

(54) METHOD OF DISPLAYING PROFILE VIEW ON INSTANT MESSAGING SERVICE

(71) Applicant: KAKAO CORP., Jeju-si (KR)

(72) Inventors: Sul Gi KIM, Yongin-si (KR); Ji Hwi PARK, Seongnam-si (KR); Yun Jin KIM, Seongnam-si (KR); Nam Hee KO, Seongnam-si (KR); Hye Seon KIM, Seongnam-si (KR); Bo Young JANG, Seongnam-si (KR); Seung Yong JI, Seongnam-si (KR); Jae Ick HWANG, Seongnam-si (KR); Sun Je BANG, Seongnam-si (KR); Ji On CHU, Seongnam-si (KR); Hye Mi LEE, Seongnam-si (KR); Shin Young LEE, Seongnam-si (KR); Seung Uk JEONG, Seongnam-si (KR); Eun Ho SON, Seongnam-si (KR); Sang Min SEO, Seongnam-si (KR); Jeong Ryeol CHOI, Seongnam-si (KR)

(21) Appl. No.: 18/505,001

(22) Filed: Nov. 8, 2023

(30) Foreign Application Priority Data
Nov. 10, 2022 (KR) 10-2022-0149491

(51) Int. Cl. H04L 51/04; G06F 3/04847; G06F 3/0488

(52) U.S. Cl. CPC H04L 51/04; G06F 3/04847; G06F 3/0488

(57) ABSTRACT

Provided is a method of operating a terminal. The method includes determining a profile item applicable to the profile view for the account based on an input received by the terminal and a coordinate indicating a position where the profile item is provided on the profile view. The method includes displaying the profile item on a screen of the terminal based on the determined profile item and the determined coordinate. The method includes receiving an input related to the profile item, and displaying a visual effect corresponding to the input on the screen.

### CROSS-REFERENCE TO RELATED APPLICATIONS

This application claims the benefit of Korean Patent Application No. 10-2022-0149491 filed on Nov. 10, 2022, in the Korean Intellectual Property Office, the entire disclosure of which is incorporated herein by reference for all purposes.

### BACKGROUND

### Technical Field

One or more embodiments relate to a method and device for displaying a profile view on an instant messaging service (IMS).

### Description of the Related Art

As various smart devices appear, including smartphones, various types of social network service (SNS) services are being used. In particular, an instant messaging application in which users open chatrooms and exchange messages in real-time in the chatrooms is widely being used. Chat services through this instant messaging application are evolving to have more various functions to meet the needs of users.

### BRIEF SUMMARY

In particular, the inventors of the present disclosure have recognized that as the range of services that can be provided through the instant messaging application expands, the possibility of usage of a profile view that represents each user is also increasing beyond simply providing a profile image. The inventors of the present disclosure have further appreciated that as the possibility of usage of the profile view increases, a service that users use to interact with other users through the profile view may also be provided.

According to an aspect, there is provided a method of operating a terminal including determining a profile item applicable to the profile view for the account based on an input received by the terminal, wherein the profile item includes at least one of a first item for at least one touch input-based interaction or a second item for slider input-based interaction, and a coordinate indicating a position where the profile item is provided on the profile view, displaying the profile item on a screen of the terminal based on the determined profile item and the determined coordinate, receiving an input related to the profile item, and displaying a visual effect corresponding to the input on the screen.

The profile item may further include at least one of a third item indicating a number of times the first item is touched by another account or a fourth item indicating a number of views of a profile.

The first item may include an emoticon indicating emotion.

The method may further include, when receiving a plurality of consecutive touch inputs at the coordinate at which the first item is provided, increasing a number of times the first item is touched and displaying the visual effect corresponding to the plurality of consecutive touch inputs on the screen.

The visual effect may include an effect in which at least one emoticon in the first item is displayed on the screen.

The method may further include displaying an emoticon in the first item on at least one coordinate of the profile view when receiving the touch input at the coordinate at which the first item is provided.

A size of the emoticon displayed on the at least one coordinate may be determined based on a selected (or in some embodiments, predetermined) first reference.

The at least one coordinate may be determined based on a selected (or predetermined) second reference.

The method may further include moving an emoticon from a first coordinate to a second coordinate that is different from the first coordinate of the profile view when receiving the touch input corresponding to the first item.

The first coordinate may be positioned above the second coordinate in a vertical direction, x-axis coordinates of the first coordinate and the second coordinate may be the same, and the second coordinate may be included in an area where a profile image is displayed on the profile view.

The moving of the emoticon from the first coordinate to the second coordinate that is different from the first coordinate may include moving the emoticon from the first coordinate to the second coordinate while changing the emoticon.

The second item may include at least one of text, a slider bar, a slider pointer capable of receiving a drag input, an image displayed on the slider pointer, or an emoticon displayed on the slider pointer.

The method may further include, when receiving a slider input from the coordinate at which the second item is provided, displaying the visual effect corresponding to the slider input on the screen.

The visual effect may include an effect in which an emoticon is displayed at a selected (or predetermined) coordinate on the screen.

The selected (or predetermined) coordinate may be a coordinate determined to be displayed in a middle of an x-axis of the screen and a middle of a y-axis of the screen on which the profile view is displayed.

The method may include, when the slider input is an input moving in a first direction, displaying an emoticon corresponding to the first direction at a selected (or predetermined) coordinate on the screen and maintaining a horizontal width of a slider bar and increasing a vertical width of a slider bar as a slider pointer moves in the first direction.

The method may further include determining a size of an emoticon displayed on the screen based on a degree of movement of a slider pointer.

The method may further include displaying profile images of the other account on a slider pointer when the slider input ends.

The method may include, when a plurality of profiles corresponding to the account exists, creating profile views corresponding to each of the plurality of profiles and determining at least one profile item to be displayed for each of the profile views based on an input signal received from the account.

The method may further include displaying an identifier in a selected (or predetermined) distance from a profile image of the account on a friend list screen.

The method may further include displaying a first item touch record on the profile view when receiving a touch input of the first item displayed on the profile view.

The method may further include displaying a second item selection record on the profile view when receiving a selection input of the second item displayed on the profile view.

### BRIEF DESCRIPTION OF THE SEVERAL VIEWS OF THE DRAWINGS

These and/or other aspects, features, and advantages of the disclosure will become apparent and more readily appreciated from the following description of embodiments, taken in conjunction with the accompanying drawings of which:

FIG. 1 is a flowchart illustrating a method of operating a server to interact with another account through a profile view of an account, according to an embodiment;

FIGS. 2A to 2C are diagrams illustrating a screen on which a first item and a plurality of emoticons, which are visual effects corresponding to the first item, are displayed, according to various embodiments;

FIGS. 3A to 3C are diagrams illustrating a first item and emoticon movement, which is a visual effect corresponding to the first item, according to various embodiments;

FIGS. 4A to 4C are diagrams illustrating a second item and a visual effect corresponding to the second item, according to various embodiments;

FIG. 5 is a diagram illustrating a screen for selecting a profile item according to an embodiment;

FIGS. 6A and 6B are diagrams illustrating a screen on which an update related to a profile item is displayed on a friend list, according to an embodiment;

FIG. 7A is a diagram illustrating a screen displaying information on accounts that select a first item on a profile view, according to an embodiment;

FIG. 7B is a diagram illustrating a screen displaying information on accounts that select a second item on a profile view, according to an embodiment;

FIG. 8 is a flowchart illustrating a method of operating a terminal to interact with another account through a profile view of an account, according to an embodiment; and

FIG. 9 is a diagram illustrating an electronic device according to an embodiment.

### DETAILED DESCRIPTION

The following detailed structural or functional description is provided as an example only and various alterations and modifications may be made to examples. Here, examples are not construed as limited to the disclosure and should be understood to include all changes, equivalents, and replacements within the idea and the technical scope of the disclosure.

Terms, such as “first”, “second”, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/including” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, examples will be described in detail with reference to the accompanying drawings. When describing the embodiments with reference to the accompanying drawings, like reference numerals refer to like elements and any repeated description related thereto will be omitted.

According to an embodiment, a server may be, for example, a server that provides an instant messaging service (IMS). The server may create accounts for each of a first user and a second user and provide the IMS to the first user and the second user through a messenger application installed on a terminal of the first user and a terminal of the second user. An account may include at least one type of, for example, an official account and a personal account. The personal account is an account for general individual users. The official account is an account for using additional functions associated with the IMS and may include, for example, a corporate account for corporate users.

According to an embodiment, the server may correspond to a service platform that provides the IMS to clients such as corporate users and individual users. The messenger application may include, for example, a computer operated to perform functions such as writing and sending text, sending multimedia content (a voice, photo, video, etc.), message notification, and scheduling, a database, a module, or a program.

According to an embodiment, the first user (or a first account) and the second user (or a second account) may access the server through a terminal on which the messenger application is installed. The first user and the second user may be individual users having personal accounts or corporate users having official accounts.

The terminal of the first user and the terminal of the second user, for example, may be one of electronic devices such as a computer, an ultra-mobile PC (UMPC), a workstation, a netbook, a personal digital assistant (PDA), a portable computer, a web tablet, a wireless phone, a mobile phone, a smartphone, an e-book, a portable multimedia player (PMP), a portable game console, a navigation device, a black box, or a digital camera, and may include all user devices capable of installing and executing a messenger application related to a service server. Under the control of the messenger application, the terminal may perform, for example, overall IMS operations such as service screen setting, data input, data transmission and reception, and data storage.

According to an embodiment, the messenger application may be implemented to be used in a mobile environment in addition to a personal computer (PC) environment and implemented in the form of a program that operates independently or configured in the form of an in-app of a certain application and implemented to be operated on the certain application.

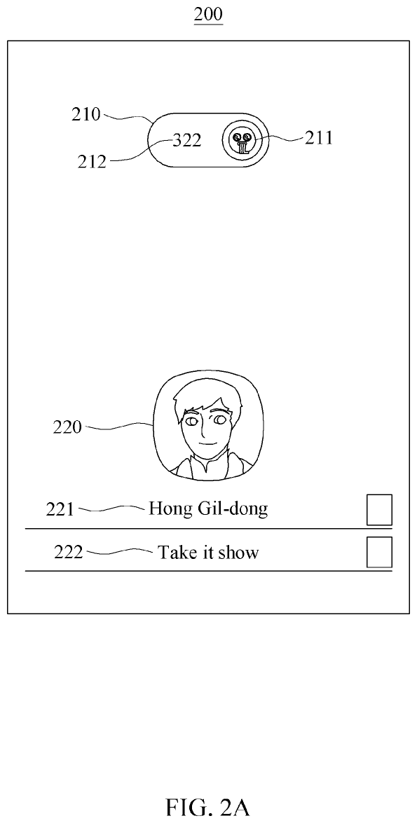

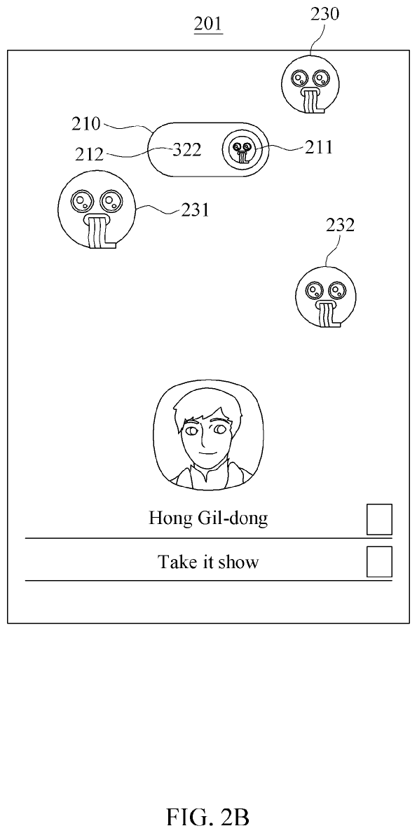

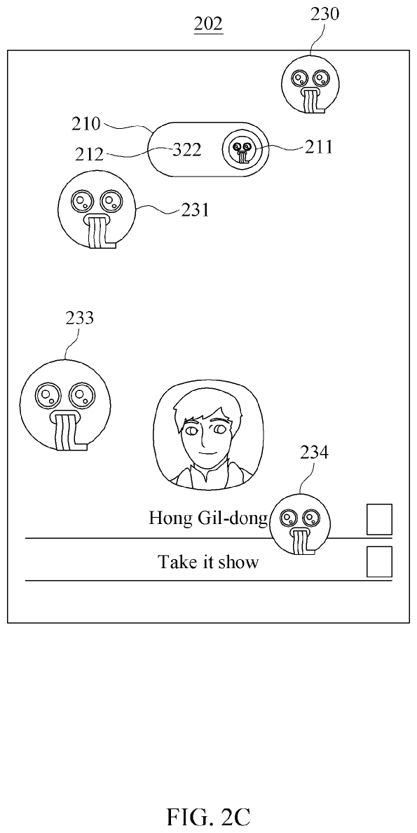

As described in more detail below, according to an embodiment, the IMS may provide a technique for improving the utilization of a profile view provided on the messenger application. The ‘profile view’ is a service screen representing a profile of a user, and for example, may be displayed on a screen of a terminal as a profile view 200 in FIG. 2A. The profile view may include, for example, a profile image and profile information provided in relation to an account of the user. According to an embodiment, the profile view may further include a profile background of profile items representing the user in various ways in addition to including only the profile image and profile information. The profile view may include, for example, different information depending on the settings of the user.

According to an embodiment, at least one profile item may be provided in the profile view. The user may apply profile item(s) to their profile view at one time. As described in more detail below, the user may freely edit the profile item(s) applied to the profile view through an edit view.

According to an embodiment, a plurality of profile items and/or a combination thereof may be applied to the profile view of a personal account. At least one profile item may include, for example, various types of items, such as a music item, a logo item, a sticker item, a text item, a link item, a background effect item, a D-day item, a background image item, a background video item, and a feedback item, that are displayed through the profile view. The music item may include, for example, a playlist of a sound source played through the profile view and a display style of the playlist.

According to an embodiment, the profile item may further include at least one of a first item for at least one touch input-based interaction, a second item for slider input-based interaction, a third item indicating the number of times the first item is touched by another account, a fourth item indicating the number of views of a profile.

The terminal may provide the edit view that edits at least one profile item applied to the profile view. The edit view may provide an edit function that applies at least one profile item described above to the profile view.

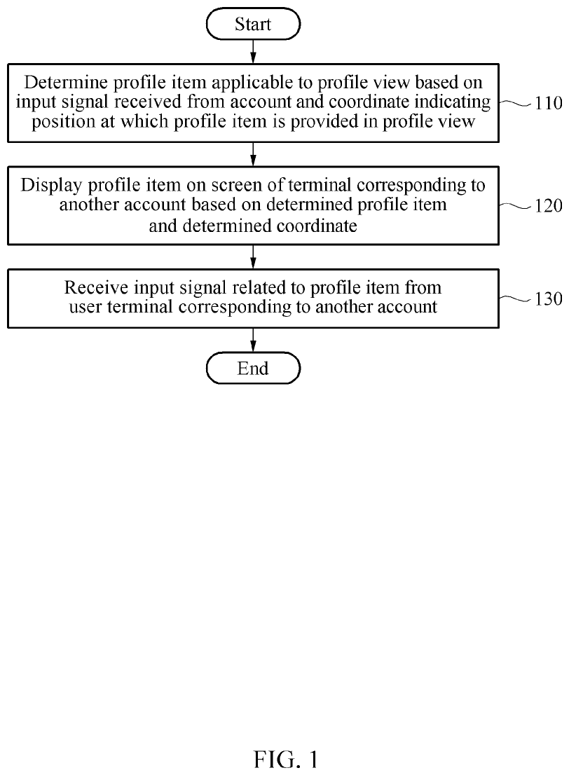

FIG. 1 is a flowchart illustrating a method of operating a server to interact with another account through a profile view of an account, according to an embodiment.

For convenience of description, the terms ‘first account’ and ‘second account’ may be used, in which the first account may refer to an account that is the owner of the profile view and the second account may refer to all accounts interacting with the first account through the profile view of the first account. Accordingly, the second account may be a single second account or a plurality of second accounts. The first account and the second account are only examples, and embodiments are not limited thereto. The operations described below may be performed on a server or a terminal, and the operations herein may not be performed to be limited to one operating subject.

In operation 110, according to an embodiment, a server may determine a profile item applicable to a profile view of an account based on an input signal received from the account and a coordinate indicating a position where the profile item is provided in the profile view. According to an embodiment, a terminal may determine a profile item applicable to a profile view of an account based on a received input signal and a coordinate indicating a position where the profile item is provided in the profile view. The profile item may include at least one of the first item for at least one touch input-based interaction or the second item for slider input-based interaction.

According to an embodiment, a screen of the terminal may be represented as an xy coordinate system. For example, the horizontal axis of the screen may be an x-axis and the vertical axis of the screen may be a y-axis. The terminal may display various objects on the screen based on a coordinate system of the screen. In addition, a user input may be received based on the coordinate system of the screen. When a position where the profile item is displayed on the screen is selected, the terminal may change the selected position to a coordinate on the coordinate system of the screen. The terminal may transmit the coordinate to the server and make the server determine the coordinate indicating the position where the profile item is provided.

According to an embodiment, the user may select the profile item applicable to the profile view. In addition, the user may select the position where the profile item is displayed on the profile view. The terminal corresponding to an account may receive, from the user, an input related to a profile item selection result and the position where the profile item is displayed. According to an embodiment, the server may receive an input signal from the terminal. For example, the server may receive information related to the profile item selected by the user and the position (e.g., the coordinate) where the profile item is displayed on the profile view.

According to an embodiment, the server or terminal may receive various types of inputs for the profile item. For example, various types of inputs may include clicking, double clicking, long clicking, consecutive clicking, touching, double touching, consecutive touching at a certain time interval, touching the profile item for a certain period of time, swiping, etc. Interaction may be performed through various types of inputs but embodiments are not limited thereto.

According to an embodiment, the first item may be an item that allows another account to express sympathy based on a touch input of an item. For example, when the first item is displayed on the profile view of the account (e.g., the first account), the first item may be displayed on the profile view of the account (e.g., the first account) on the screen of another account (e.g., the second account). In addition, a user of another account (e.g., the second account) may touch (or click) the first item to sympathize with the emotion of the account (e.g., the first account). The user of another account (e.g., the second account) may touch (or click) the first item multiple times as the degree of sympathy increases. Accordingly, as the number of times the first item is touched (or clicked) increases, it may be interpreted that the degree of sympathy increases.

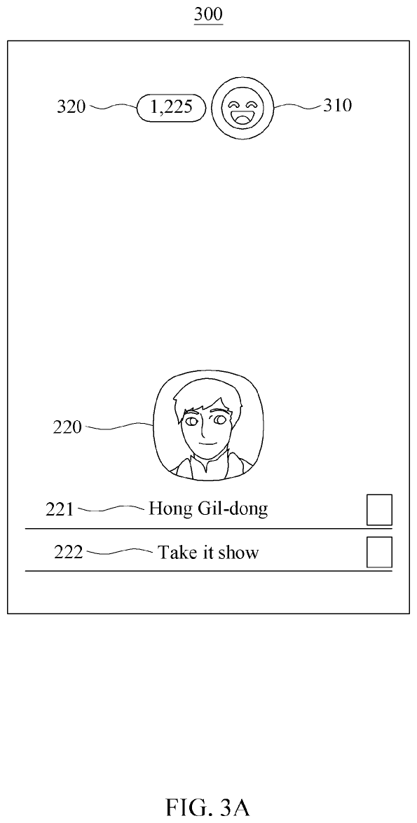

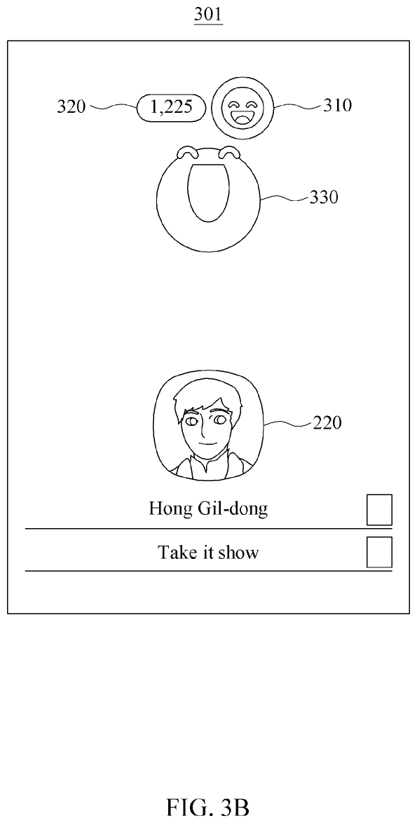

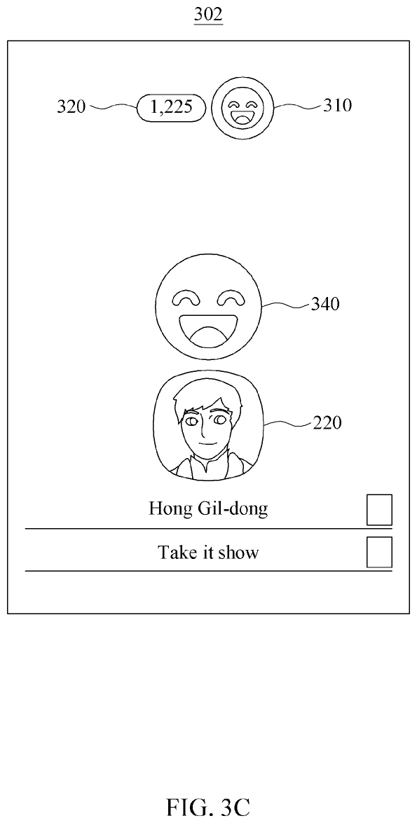

According to an embodiment, the first item may include an emoticon indicating emotion. For example, the emoticon may be displayed with the third item indicating the number of times the first item is touched (or clicked) on the profile view. Referring to FIG. 2A, an emoticon 211 in a first item 210 may be displayed side-by-side with a third item 212 on the profile view. In FIG. 2A, the third item 212 may be displayed as included in the first item 210 on the profile view. Referring to FIG. 3A, a first item 310 may include an emoticon. In addition, a third item 320 may be displayed side-by-side with the first item 310 on the profile view. In this case, the first item 310 and the third item 320 may be displayed separately on the profile view.

According to an embodiment, the second item may be an item that allows another account to express sympathy based on a slider input. A slider may be an object that allows a user to select a numerical value in a selected (or in some embodiments, predetermined) range by manipulating a slider pointer. For example, when the second item is displayed on the profile view of the account (e.g., the first account), the second item may be displayed on the profile view of the account (e.g., the first account) on the screen of another account (e.g., the second account). In addition, the user of another account (e.g., the second account) may select the degree of sympathy using the second item to sympathize with the emotion of the account (e.g., the first account). The user of another account (e.g., the second account) may select a large value by moving the slider pointer in the second item as the degree of sympathy increases. Accordingly, it may be interpreted that the degree of sympathy increases as the slider pointer in the second item is positioned on the right of a slider bar. (In this case, the initial position of the slider pointer may be the left end of the slider bar.) The direction for expressing the degree of sympathy (left to right or right to left) is only an example, and embodiments are not limited thereto.

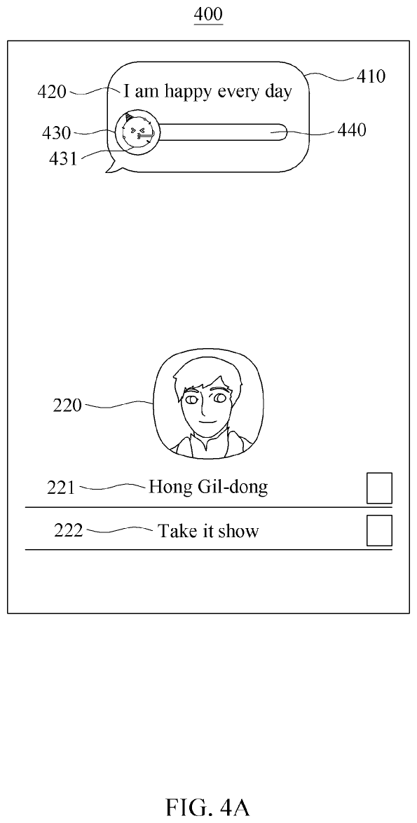

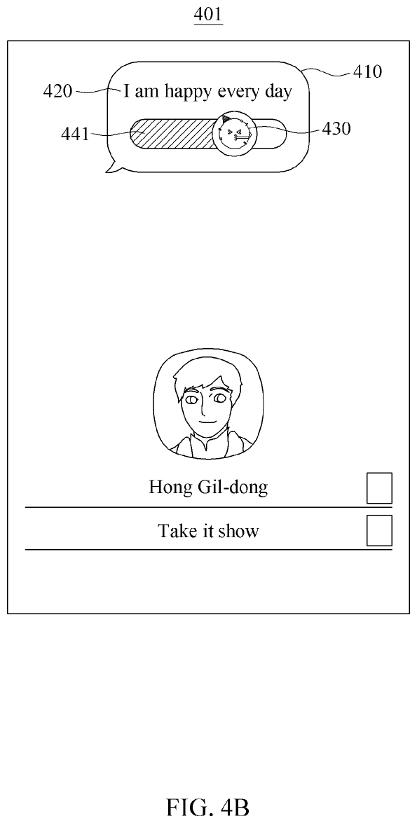

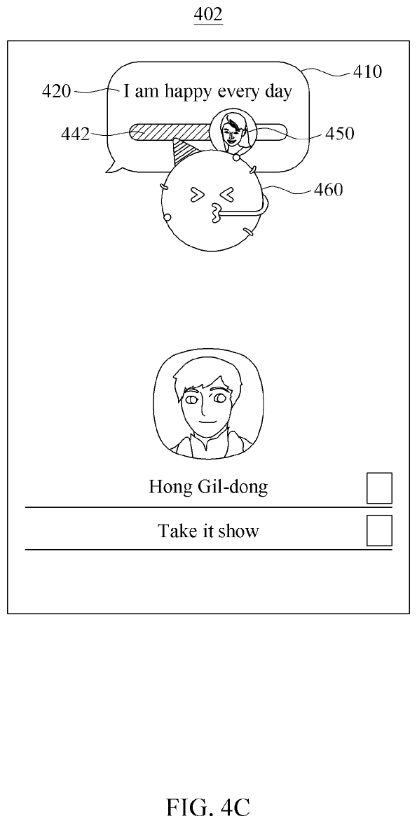

According to an embodiment, the second item may include at least one of text, the slider bar, the slider pointer capable of receiving a drag input, an image displayed on the slider pointer, or an emoticon displayed on the slider pointer. Referring to FIG. 4A, text 420, a slider pointer 430, and an emoticon 431 displayed on the slider pointer 430 may be displayed in a second item 410 on a profile view 400. The text 420 may be text input by the user of the account (e.g., the first account). The user may express their emotional status as text. For example, the emotional status expressed by the user as text may be “I am happy every day.” The user of another account (e.g., the second account) may sympathize with the text 420 displayed on the profile view 400 of the account (e.g., the first account) displayed on the screen of the terminal. The user of another account (e.g., the second account) may move the slider pointer 430 from left to right (e.g., a first direction) to convey sympathy to the first account. The degree of movement of the slider pointer 430 may be proportional to the degree of sympathy. Accordingly, the more the user of another account (e.g., the second account) moves the slider pointer 430 in the first direction, the greater the indication of sympathy may be conveyed to the account (e.g., the first account).

In operation 120, according to an embodiment, the server may display the profile item on the screen of the terminal corresponding to another account based on the determined profile item and the determined coordinate. According to an embodiment, the terminal may display the profile item on the screen of the terminal based on the determined profile item and the determined coordinate. In operation 110, the user of the account (e.g., the first account) may select at least one profile item through the edit view and determine the position where at least one selected profile item is displayed. In addition, the server (or the terminal of the corresponding account) may complete the profile view of the account (e.g., the first account) based on the user selection of the account. In addition, the server (or the terminal of another account) may display the profile view of the corresponding account on the screen of the terminal of another account (e.g., the second account) that is viewing the profile view of the account (e.g., the first account). Accordingly, operation 120 may be an operation in which another account (e.g., the second account) views the profile view of the account (e.g., the first account) and the profile view of the corresponding account is displayed on the screen of the terminal of another account.

According to an embodiment, the profile item may further include at least one of the third item indicating the number of times the first item is touched (or clicked) by another account or the fourth item indicating the number of views of the profile. The third item may be an object that displays the number of times the first item is touched (or clicked) by another account. The fourth item may be an object that displays the number of times another account views the profile of the corresponding account during a certain period of time. For example, the fourth item may display the number of views of the profile of the corresponding account by another account during the day.

In operation 130, according to an embodiment, the server may receive an input signal related to the profile item from the terminal corresponding to another account. The server may receive the input signal related to the profile item and store the number of times the profile item is selected (e.g., the number of times the first item is selected by another account), the time the profile item is selected (e.g., the time the first item is selected), and account information that selects the profile item (information related to an account that selects the first item). According to an embodiment, the terminal may receive an input related to the profile item. The input may be an input received from a user. The user of another account (e.g., the second account) may convey sympathy to the first account through the profile item displayed on the profile view of the account (e.g., the first account). The input signal may be created by an action of the user of another account who selects the profile item. For example, the user of another account may convey sympathy and the degree of sympathy to the corresponding account by touching (or clicking) the first item displayed on the profile view of the corresponding account at least once. In another example, the user of another account may convey sympathy and the degree of sympathy to the corresponding account by moving the slider pointer of the second item displayed on the profile view of the corresponding account.

According to an embodiment, the server may transmit data for displaying a visual effect corresponding to the input signal on the screen. According to an embodiment, the terminal may display the visual effect corresponding to the input signal on the screen. The terminal may receive data for displaying the visual effect on the screen of the terminal and display the visual effect on the screen. When data for displaying the visual effect on the screen of the terminal is stored in the terminal, the terminal may display the visual effect corresponding to the input on the screen without communication with the server. The data for displaying the visual effect on the screen may be data required for displaying the visual effect on the terminal. The visual effect may be set differently for each profile item and the server may determine the visual effect that matches the profile item to input signal. The server may transmit data for displaying the visual effect corresponding to the input signal on the screen of the terminal of another account (e.g., the second account) to the terminal. The visual effect may be displayed on the screen of the terminal of another account (e.g., the second account) when another account (e.g., the second account) conveys sympathy to the account (e.g., the first account) and may be the visual effect displayed on the profile view of the corresponding account.

Detailed embodiments related to the visual effect are described in detail below with reference to FIGS. 2A to 2C, 3A to 3C, and 4A to 4C.

A user of an account may send the indication of sympathy to other users using the profile item provided in the profile view and a user of an account who receives the indication of sympathy may see the account list that sends sympathy. The user of the account who receives the indication of sympathy may also convey sympathy to the account selected from the account list. Accordingly, through the profile item provided in the profile view, users may interact with each other by sympathizing with each emotional status displayed on the profile view. Through sympathy-based interaction, users online may form greater inner intimacy.

According to an embodiment, a plurality of profiles may exist in one account. The plurality of profiles corresponding to one account may be referred to as a multi-profile. A user may register at least one profile item in the profile view corresponding to each of the plurality of profiles.

According to an embodiment, when the plurality of profiles corresponding to an account exists, the server (or the terminal) may create profile views corresponding to each of the plurality of profiles. The server may determine at least one profile item to be displayed for each profile view based on the input signal received from the account. The terminal may determine at least one profile item to be displayed for each profile view based on the received input signal. The profile item may include at least one of the first item, the second item, the third item, or the fourth item. According to an embodiment, when the plurality of profiles corresponding to the account exists, at least one profile item registered in each of the plurality of profiles may be the same or different. For example, the server (or the terminal) may create the profile view for each of profile A, profile B, and profile C corresponding to account A. A user may determine whether to register at least one profile item for each of the profile A, the profile B, and the profile C. For example, the user may register the first item in the profile A and the second item in the profile B.

FIGS. 2A to 2C are diagrams illustrating a screen on which a first item and a plurality of emoticons, which are visual effects corresponding to the first item, are displayed, according to various embodiments.

According to an embodiment, FIG. 2A may be a screen in which the first item 210 is displayed on a profile view. The emoticon 211 and the third item 212 may be displayed on the first item 210 at the same time. The emoticon 211 may be determined based on the user selection. The user may determine an emoticon based on their emotional status. Accordingly, the emoticon 211 displayed on the profile view 200 may express the current emotional status of the user. A profile image 220, an account name 221, and a status message 222 may be displayed on the profile view 200. The profile view 200 described above is only an example, and some components may be omitted or other components may be further included.

According to an embodiment, when receiving a plurality of consecutive touch inputs at a coordinate at which the first item 210 is provided, the server (or the terminal) may increase the number of times the first item 210 is touched (or clicked). The terminal of another account (e.g., the second account) may receive the plurality of consecutive touch inputs at the coordinate at which the first item 210 is provided from a user of another account. The terminal may determine whether to input the plurality of consecutive touch inputs based on whether the plurality of consecutive touch inputs is received at the corresponding coordinate at a regular time interval. For example, when the touch input is input multiple times at an interval of about 200 milliseconds (ms) at the coordinate at which the first item 210 is provided, the terminal may recognize the touch input as the plurality of consecutive touch inputs.

As the server (or the terminal) allows a user to make the plurality of consecutive touch inputs, when the user expressing sympathy wants to strongly sympathize with the emotional status of other users, the user may express the indication of sympathy through the consecutive touch inputs. When the plurality of consecutive touch inputs is not allowed, the user may feel frustrated in expressing sympathy because the user must wait a certain amount of time and then touch (or click) the first item 210 again.

According to an embodiment, the server (or the terminal) may display the visual effect corresponding to the plurality of consecutive touch inputs on the screen (e.g., the profile view 200). The visual effect may refer to an effect in which at least one emoticon is displayed on the profile view 200. For example, the visual effect may include visual effects in which at least one emoticon blinks, moves, changes the size, or changes the transparency of the emoticon on the profile view 200.

According to an embodiment, the visual effect may include an effect in which at least one emoticon in the first item 210 is displayed on the screen. According to an embodiment, when receiving the touch input at the coordinate at which the first item 210 is provided, the server (or the terminal) may display the emoticon in the first item 210 on at least one coordinate of the profile view 200. According to an embodiment, the size of the emoticon displayed at least one coordinate may be determined based on a selected (or predetermined) first reference. The selected (or predetermined) first reference may be a reference that sets the size of at least one emoticon to be different or sets the size of some emoticons to be the same. According to an embodiment, at least one coordinate may be determined based on a selected (or predetermined) second reference. The selected (or predetermined) second reference may be a reference arbitrarily determined by the server. For example, the server (or the terminal) may arbitrarily determine the position of the emoticon. The server (or the terminal) may determine a coordinate at which at least one emoticon is displayed on the profile view 200 in advance. In addition, when displaying the visual effect, the server (or the terminal) may display at least one emoticon at the selected (or predetermined) coordinate on the screen. The emoticon used in the visual effect may be the same as or different from the emoticon 211 in the first item 210. The visual effect is described in detail below with reference to FIGS. 2B and 2C. The visual effect may be an effect in which at least one emoticon appears and disappears at the certain position of the profile view 200.

According to an embodiment, three emoticons 230, 231, and 232 may be displayed on a profile view 201 of FIG. 2B. At least one of the size, position, or transparency of at least one emoticon displayed on the profile view 201 may be the same or different. A profile view 202 of FIG. 2C may be a profile view displayed in the next frame (e.g., the next time) of the profile view 201 of FIG. 2B. The emoticon 230 may be maintained at a corresponding coordinate in the profile view 202 of FIG. 2C. As the transparency of the emoticon 231 increases, the emoticon 231 may gradually disappear from the profile view 202. The emoticon 232 may completely disappear from the profile view 202. Emoticons 233 and 234 may be newly created at selected (or predetermined) coordinates. In this way, the server (or the terminal) may display the visual effect in which emoticons are displayed and disappear at the selected (or predetermined) coordinate from the profile view on the screen of the terminal.

According to an embodiment, as the number of consecutive touch inputs to the coordinate at which the first item 210 is provided increases, the number of emoticons displayed in the profile view may increase. For example, when the number of consecutive touch inputs is greater than or equal to 30 times and less than or equal to 50 times, the number of emoticons displayed on the profile view is 4, and when the number of consecutive touch inputs is greater than or equal to 51 times and less than or equal to 70 times, the number of emoticons displayed on the profile view is 6. Through this, as the degree of sympathy for the account (e.g., the first account) by the user of another account (e.g., the second account) increases, the number of displayed emoticons increases and the user of another account (e.g., the second account) may feel the dramatic effect of sympathy.

FIGS. 3A to 3C are diagrams illustrating a first item and emoticon movement, which is a visual effect corresponding to the first item, according to various embodiments.

According to an embodiment, FIG. 3A may be a screen in which the first item 310 is displayed on a profile view 300. An emoticon may be displayed on the first item 310. In addition, the third item 320 indicating the number of times the first item 310 is touched may be displayed next to the first item 310. The position where the third item 320 is displayed is only an example and may be displayed with the first item 310 or separately. The profile view 300 described above is only an example, and some components may be omitted or other components may be further included.

According to an embodiment, when receiving a touch input corresponding to the first item 310, the server (or the terminal) may move the emoticon from a first coordinate to a second coordinate that is different from the first coordinate of the profile view 300. According to an embodiment, when receiving the touch input corresponding to the first item 310, the server (or the terminal) may move the emoticon in the first item 310 from the first coordinate to the second coordinate that is different from the first coordinate of the profile view 300. For example, the terminal of another account (e.g., the second account) may receive, from a user, the touch input at a coordinate at which the first item 310 is provided.

According to an embodiment, the first coordinate may be positioned above the second coordinate in the vertical direction. In this case, the server (or the terminal) may move the emoticon from the upper end to the lower end of the profile view 300 based on the corresponding coordinate. For example, the visual effect may be in the form in which the emoticon moves behind a profile image while falling downwards from the upper end of the profile view 300. For example, a first coordinate 330 displayed on a profile view 301 of FIG. 3B may be positioned above a second coordinate 340 displayed on a profile view 302 of FIG. 3C. When the horizontal axis of the screen is an x-axis and the vertical axis of the screen is a y-axis, an x-axis coordinate of the first coordinate 330 may be the same as an x-axis coordinate of the second coordinate 340. In addition, a y-axis coordinate of the first coordinate 330 may be greater than a y-axis coordinate of the second coordinate 340. The second coordinate 340 may be included in an area where the profile image is displayed on the profile view 302. For example, when the area where the profile image 220 is displayed includes the second coordinate 340, the emoticon may move behind the profile image 220. By including the second coordinate 340 in the area where the profile image 220 is displayed, the server (or the terminal) may obtain the visual effect that causes the emoticon to disappear behind the profile image 220.

According to an embodiment, the first coordinate 330 may be positioned below the second coordinate 340 in the vertical direction. In this case, the server (or the terminal) may move the emoticon from bottom to top based on a corresponding coordinate. For example, the visual effect may be in the form in which the emoticon comes out of the profile image 220 and goes upwardly.

According to an embodiment, the server (or the terminal) may move the emoticon from the first coordinate 330 to the second coordinate 340 while changing the emoticon. For example, the emoticon displayed on the first coordinate 330 may be different from the emoticon displayed on the second coordinate 340. For example, the emoticon displayed on the first coordinate 330 may be an emoticon smiling while looking upwardly. For example, the emoticon displayed on the second coordinate 340 may be an emoticon smiling while looking straight ahead. The server (or the terminal) may change the emoticon while changing the emoticon according to the gaze of the emoticon, while moving the emoticon from the first coordinate 330 to the second coordinate 340. Through this, the server (or the terminal) may show more dynamic visual effect to a user.

FIGS. 4A to 4C are diagrams illustrating a second item and a visual effect corresponding to the second item, according to various embodiments.

Detailed description related to the second item 410 of FIG. 4A is provided with reference to FIG. 1, and accordingly, the description thereof is omitted in this drawing.

According to an embodiment, when receiving a slider input at the coordinate at which the second item 410 is provided, the server (or the terminal) may display the visual effect corresponding to the slider input on the screen. The visual effect may include an effect in which the emoticon is displayed at a selected (or predetermined) coordinate on the screen. The selected (or predetermined) coordinate may be a coordinate arbitrarily determined by the server or a user. For example, the selected (or predetermined) coordinate may be a coordinate determined to be displayed in the middle of the x-axis of the screen and the middle of the y-axis of the screen on the screen on which the profile view is displayed. Through this, the emoticon may be displayed in the middle of the screen.

According to an embodiment, when the slider input is an input moving in the first direction, the server (or the terminal) may display the emoticon corresponding to the first direction at the selected (or predetermined) coordinate on the screen. The first direction may be a direction in which the slider pointer 430 moves from left to right. A second direction may be opposite to the first direction. When the slider pointer 430 moves in the second direction, the emoticon may not be displayed or an emoticon that is different from the emoticon corresponding to the first direction may be displayed on the screen.

According to an embodiment, as the slider pointer 430 moves in the first direction, the server (or the terminal) may maintain the horizontal width of a slider bar and increase the vertical width of the slider bar. For example, in FIG. 4A, the slider pointer 430 may be positioned on the left of a slide bar 440 and the vertical width of the slider bar 440 may be less than the diameter of the slider pointer 430. In FIG. 4B, as the slider pointer 430 moves in the first direction, the vertical width of a slider bar 441 increases and becomes the same as the diameter of the slider pointer 430. Even when the slider pointer 430 moves in the first direction, the vertical width of the slider bar 441 may be maintained. This is because the range of numerical values that a user may select remains unchanged. Through this visual effect, the user of another account (e.g., the second accounts) who expresses sympathy may visually perceive that the degree of sympathy increases.

Referring to FIG. 4C, when a user finishes the slider input through the second item 410, the server (or the terminal) may display the emoticon at the selected (or predetermined) coordinate. For example, the server (or the terminal) may display the emoticon at a selected (or predetermined) coordinate 460, as shown in FIG. 4C. When the user finishes the slider input through the second item 410, the server (or the terminal) may change the vertical width of a slider bar 442 to the original vertical width. Accordingly, when the user moves a slider pointer 450 in the first direction, the vertical width of the slider bar 442 increases, and the movement of the slider pointer 450 ends, the server (or the terminal) may restore the vertical width of the slider bar 442 to the original length.

Referring to FIG. 4C, according to an embodiment, when the slider input ends, the server (or the terminal) may display a profile image of another account on the slider pointer 450. For example, a profile view 402 of the account (e.g., the first account) may be displayed on the screen of another account (e.g., the second account). In addition, the second item 410 may be displayed on the profile view 402. The user of another account (e.g., the second account) may end the slider input. In this case, the server (or the terminal) may display a profile image 450 of another account (e.g., the second account) on the slider pointer 430.

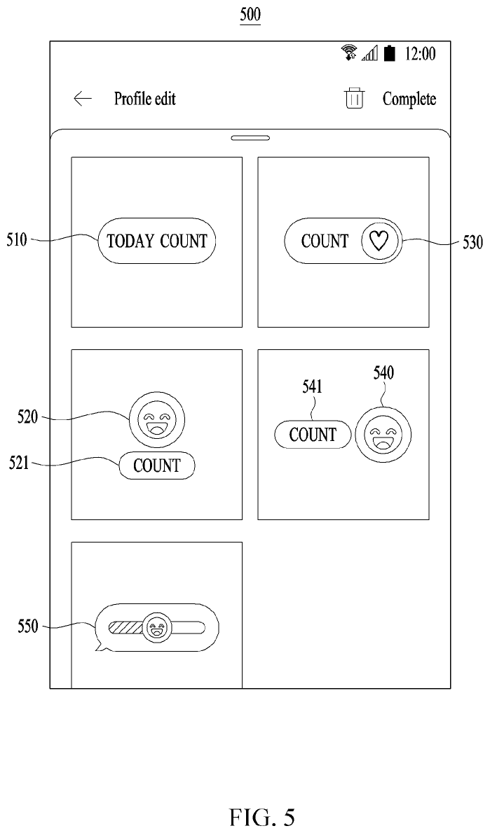

FIG. 5 is a diagram illustrating a screen for selecting a profile item according to an embodiment.

In FIG. 5, first items 520 and 540, a second item 550, and fourth items 510 and 530 are shown. The profile items shown in FIG. 5 are only examples, and embodiments are not limited thereto. The user of the account (e.g., the first account) may select a profile item to be displayed in their profile view through a screen 500. As shown in FIG. 5, third items 521 and 541 may be provided as one profile item with the first items 520 and 540.

According to an embodiment, the server (or the terminal) may limit the profile item to be displayed on the profile view without exceeding the selected (or predetermined) number. For example, the server may limit only up to three profile items to be displayed on the profile view. For example, a user may insert the three first items 520 and 540 into the profile view. For example, the user may insert the one first items 520 and 540, the one second item 550, and the one fourth items 510 and 530 into the profile view. When the user selects the profile item exceeding the selected (or predetermined) number, the server (or the terminal) may display an error message on the screen.

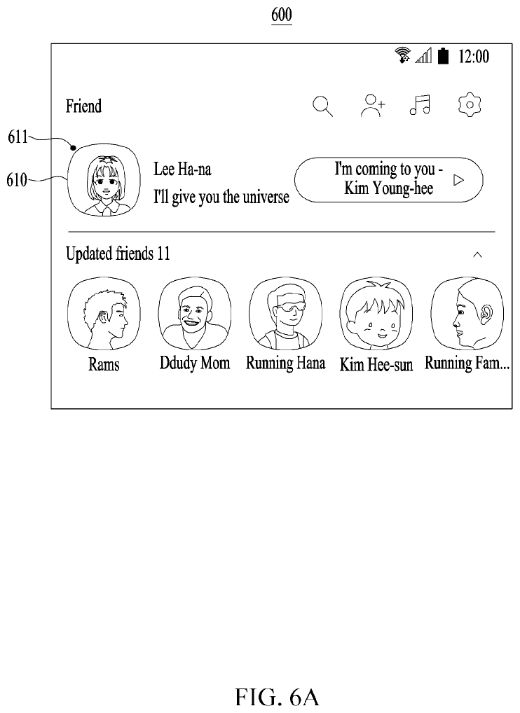

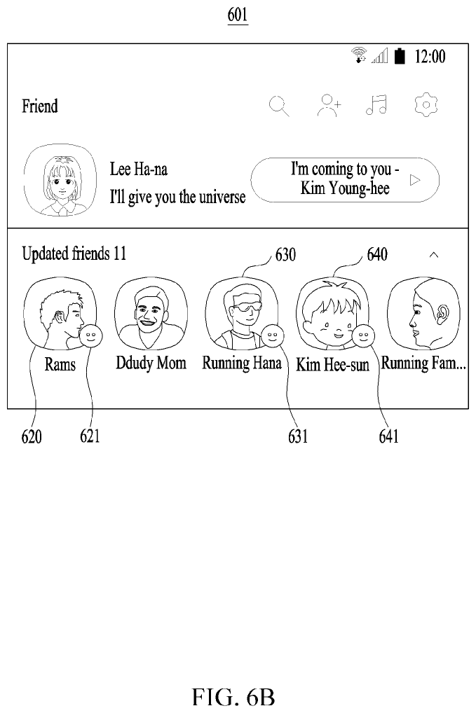

FIGS. 6A and 6B are diagrams illustrating a screen on which an update related to a profile item is displayed on a friend list, according to an embodiment.

In FIG. 6A, an identifier near a profile image of the account (e.g., the first account) on a friend list screen 600 may be displayed. The server (or the terminal) may display the identifier in a selected (or predetermined) distance from the profile image of the account on the friend list screen 600. For example, the server (or the terminal) may display the identifier on the left upper end from the profile image. The friend list screen 600 may be a screen of the first account. For example, an identifier 611 may be displayed near a profile image 610. When the first item or the second item corresponding to the corresponding account is selected by another account (e.g., the second account), the identifier 611 displayed near the profile image 610 of the account (e.g., the first account) may notify the selection to the account (e.g., the first account).

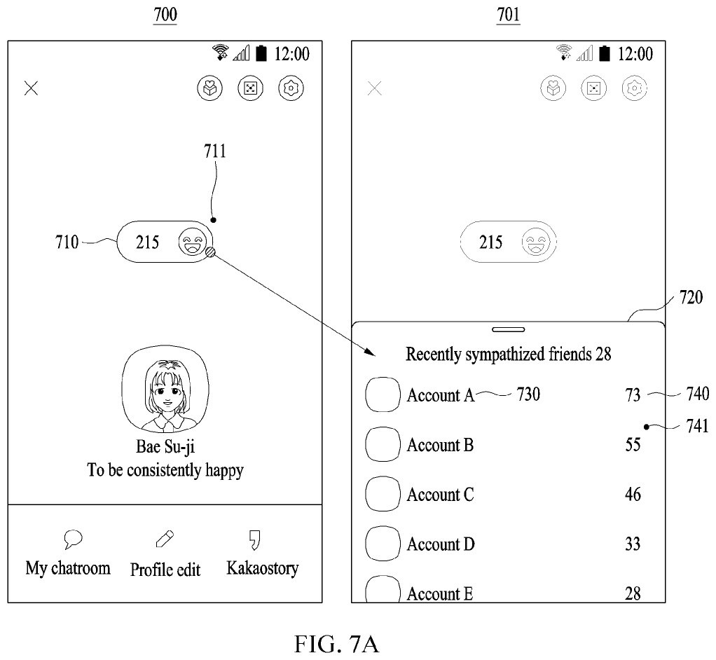

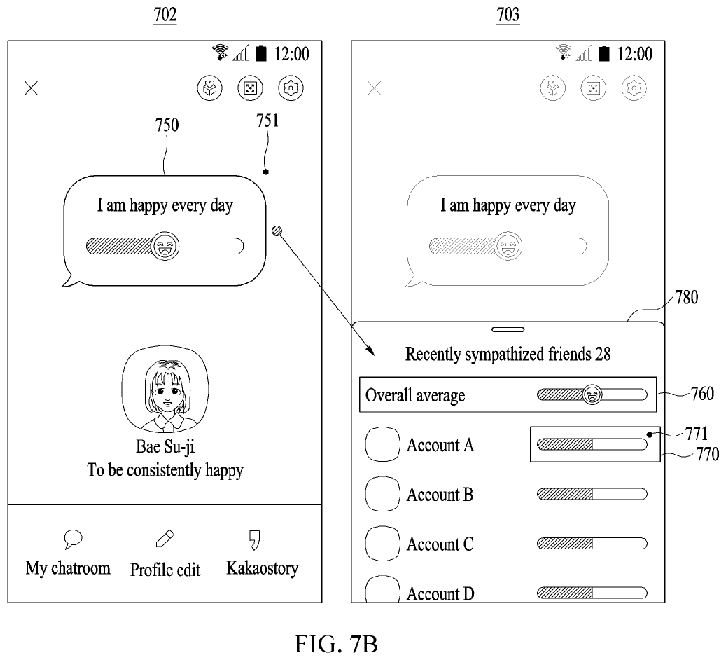

According to an embodiment, when receiving a selection input of the profile image 610, the server (or the terminal) may not display the identifier 611 on the screen. When the profile image 610 is selected, the server (or the terminal) may change the screen to the profile view of the corresponding account. The changed profile view is described below with reference to FIG. 7A. According to an embodiment, when the first item or the second item is not selected for a certain period of time (e.g., 7 days), the server (or the terminal) may not display the identifier 611 on the screen. According to an embodiment, when another account cancels the selection input of the first item or the second item, the server (or the terminal) may not display the identifier 611 on the screen. For example, the server (or the terminal) may cancel a touch (or a click) input of the first item. The server (or the terminal) may cancel a slider input of the second item. When an input to cancel selection of the first item or the second item is received, the selection input cancellation pop-up window may be displayed on the screen. The confirm button and cancel button may be displayed on the pop-up window. When the confirm button is selected, the number of times (e.g., the touch input, click input, slider input, etc.) the item is selected displayed on the profile view of the corresponding account by another account may be deducted from the total number of selections. When the cancel button is selected, the pop-up window may disappear. According to an embodiment, when receiving the selection input of the first item or the second item after the identifier 611 is removed, the server (or the terminal) may display the identifier 611 on the screen again.

In FIG. 6B, another account (e.g., the second account) that is friends with the account (e.g., the first account) may be displayed on a friend list screen 601. Another account that updated their profile among other accounts that are friends with the corresponding account may be displayed on the friend list screen 601. For example, when another account (e.g., the second account) registers at least one of the first item, the second item, the third item, or the fourth item in the profile view, an identifier may be displayed near a profile image of the registered account. For example, there may be a case in which account A, account B, and account C register at least one of the first item, the second item, the third item, or the fourth item in the profile view. In this case, the server (or the terminal) may display an identifier 621 near a profile image 620 of the account A, display an identifier 631 near a profile image 630 of the account B, and display an identifier 641 near a profile image 640 of the account C. There may be various methods to distinguish and display an account that registers at least one of the first item, the second item, the third item, or the fourth item from an account that is not updated on the profile view. However, the identifiers described above are only examples, and embodiments are not limited thereto.

FIG. 7A is a diagram illustrating a screen displaying information on accounts that select a first item on a profile view, according to an embodiment.

According to an embodiment, the user of the account (e.g., the first account) may see, on the screen, a list of other accounts that touch (or click) the first item registered by themselves in the profile view. The profile view of the account (e.g., the first account) may be displayed on a screen 700. In addition, a first item 710 and an identifier 711 may be displayed on the corresponding profile view. The screen 700 may be a profile view that is changed when a user selects the profile image 610 in FIG. 6A. For example, the first item 710 may display the number of times the first item 710 is touched (or clicked). For example, when the selected number is 215 times, 215 may be displayed on the first item 710. For example, after the account (e.g., the first account) views its profile view or confirms a first item touch record 720, when a record that the first item 710 is newly touched (or clicked) by another account exists, the identifier 711 may be displayed on the screen.

According to an embodiment, at least one of a profile image, a profile name, a status message, my chatroom object, a profile edit object, or a story object may be displayed on the screen 700, which is an example of the profile view. My chatroom object may be an object that is changed to a chatroom where a participant in the chatroom is the owner account of the profile view. Through my chatroom function, a user may have a record that only the user may see in the chatroom. When the profile edit object is selected, the screen may be changed to the edit view. When the story object is selected, another application interoperating with the instance messaging application may be executed. The story application may be an application used by the user to record their daily life.

According to an embodiment, when receiving the touch input of the first item 710, the server (or the terminal) may display the first item touch record 720 on the profile view. In a screen 702, the first item touch record 720 is displayed at the lower end of the screen. However, this is only an example, and embodiments are not limited thereto. The first item touch record 720 may include a list of other accounts that touch the first item 710 and the number of times each account touches the first item 710. For example, the number of times 740 an account A 730 touches the first item 710 may be 73 times. When an account that newly touches the first item 710 exists, the server may display an identifier 741. For example, when account B newly touches the first item 710, the server may display the identifier 741 on the screen.

According to an embodiment, the server (or the terminal) may receive the touch input of the first item 710 displayed on the profile view of the corresponding account from at least one of an account blocked by the corresponding account or an account hidden by the corresponding account. The account blocked by the corresponding account may have a limitation in that a message is not sent to the corresponding account. The account hidden by the corresponding account may be an account that is not displayed on the list of friends of the corresponding account. The account blocked by the corresponding account or the account hidden by the corresponding account may convey sympathy to the corresponding account. For example, the account blocked by the corresponding account or the account hidden by the corresponding account may convey sympathy through at least one of the first item 710 or the second item. When the server (or the terminal) receives the touch input of the first item 710 displayed on the profile view of the corresponding account from at least one of the account blocked by the corresponding account or the account hidden by the corresponding account, at least one of the account blocked by the corresponding account or the account hidden by the corresponding account may be displayed on the first item touch record 720.

FIG. 7B is a diagram illustrating a screen displaying information on accounts that select a second item on a profile view, according to an embodiment.

According to an embodiment, the user of the account (e.g., the first account) may see, on the screen, the list of another account that selects the second item 750 registered by himself or herself in the profile view. The profile view of the account (e.g., the first account) may be displayed on the screen 702. In addition, a second item 750 and an identifier 751 may be displayed on the profile view. The screen 702 may be a profile view that is changed when a user selects the profile image 610 in FIG. 6A. For example, after the account (e.g., the first account) views its profile view or confirms a second item selection record 780, when a record that the second item 750 is newly selected by another account (e.g., the second account) exists, the identifier 751 may be displayed on the screen.

According to an embodiment, when receiving the selection input of the second item 750, the server may display a second item selection record 780 on the profile view. In a screen 703, the second item selection record 780 is displayed at the lower end of the screen. However, this is only an example, and embodiments are not limited thereto. The second item selection record 780 may include the list of another account that selects the second item 750 and slider-based input information of the second item 750 corresponding to each account. For example, the value input by the account A through a slider may be displayed as the slider. After the account (e.g., the first account) views the profile view or confirms the second item selection record 780, when another account (e.g., the account A) newly inputs the second item 750, an identifier 771 may be displayed. According to an embodiment, the server may display an overall average 760 of slider-based input values in the second item selection record 780 on the screen. For example, the overall average 760 may be displayed as the slider.

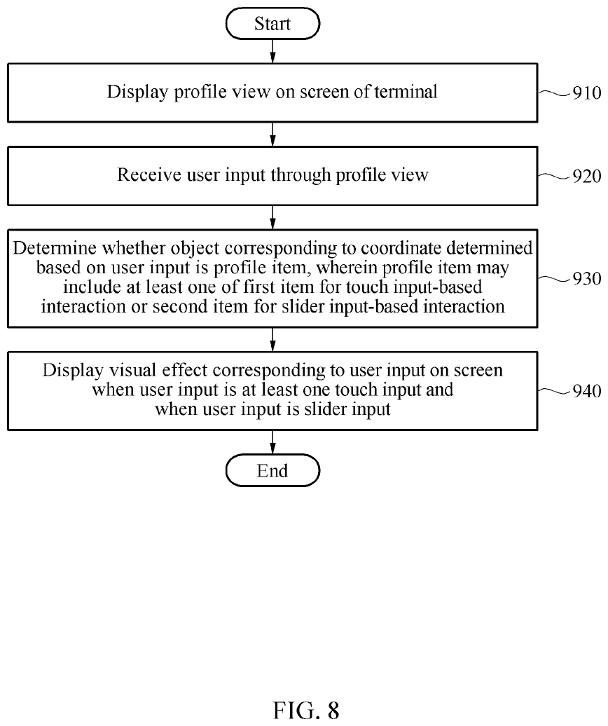

FIG. 8 is a flowchart illustrating a method of operating a terminal to interact with another account through a profile view of an account, according to an embodiment.

In operation 910, according to an embodiment, a terminal may display a profile view on a screen of the terminal. The terminal may display the profile view corresponding to a certain account on the screen based on data received from a server or data stored in the terminal.

In operation 920, according to an embodiment, the terminal may receive a user input through the profile view. The profile view may be displayed on the screen of the terminal and the user may select a profile item through the profile view displayed on the screen. For example, when the terminal receives the user input for the profile item, the terminal may obtain a coordinate at which the user input is received on the screen.

In operation 930, according to an embodiment, the terminal may determine whether an object corresponding to the coordinate determined based on the user input is a profile item, wherein the profile item may include at least one of a first item for touch input-based interaction or a second item for slider input-based interaction. When obtaining the coordinate at which the user input is received, the terminal may identify the object corresponding to the coordinate. In addition, the terminal may determine whether the object is the profile item. The terminal may determine whether the object is the first item or the second item. Further, the terminal may determine whether the object is the first item, the second item, a third item, or a fourth item.

In operation 940, according to an embodiment, the terminal may display a visual effect corresponding to the user input on the screen when the user input is at least one touch input and when the user input is a slider input. In operation 940, the terminal may receive data for displaying the visual effect on the screen from the server. In addition, the terminal may display the visual effect on the screen based on the received data. For example, when the user selects the first item, the terminal may display the visual effect corresponding to the touch input on the screen. For example, when the user selects the second item, the terminal may display the visual effect corresponding to the slider input on the screen.

According to an embodiment, when receiving a plurality of consecutive touch inputs at a coordinate at which the first item is provided, the terminal may increase the number of times the first item is touched and display the visual effect corresponding to the plurality of consecutive touch inputs on the screen.

According to an embodiment, the visual effect may include an effect in which at least one emoticon in the first item is displayed on the screen.

According to an embodiment, when receiving a touch input at the coordinate at which the first item is provided, the terminal may display the emoticon in the first item on at least one coordinate of the profile view.

According to an embodiment, when receiving the touch input corresponding to the first item, the terminal may move the emoticon from a first coordinate to a second coordinate that is different from the first coordinate of the profile view.

According to an embodiment, the first coordinate may be positioned above the second coordinate in the vertical direction, x-axis coordinates of the first coordinate and the second coordinate are the same, and the second coordinate may be included in an area where a profile image is displayed on the profile view.

According to an embodiment, the terminal may move the emoticon from the first coordinate to the second coordinate while changing the emoticon.

According to an embodiment, when receiving a slider input at a coordinate at which the second item is provided, the terminal may display the visual effect corresponding to the slider input on the screen.

According to an embodiment, when the slider input is an input moving in a first direction, the terminal may display an emoticon corresponding to the first direction at a selected (or predetermined) coordinate on the screen.

According to an embodiment, as a slider pointer moves in the first direction, the terminal may maintain the horizontal width of a slider bar and increase the vertical width of the slider bar.

According to an embodiment, the terminal may determine the size of the emoticon displayed on the screen based on the degree of movement of the slider pointer.

According to an embodiment, when the slider input ends, the terminal may display a profile image of an account corresponding to the terminal on the slider pointer.

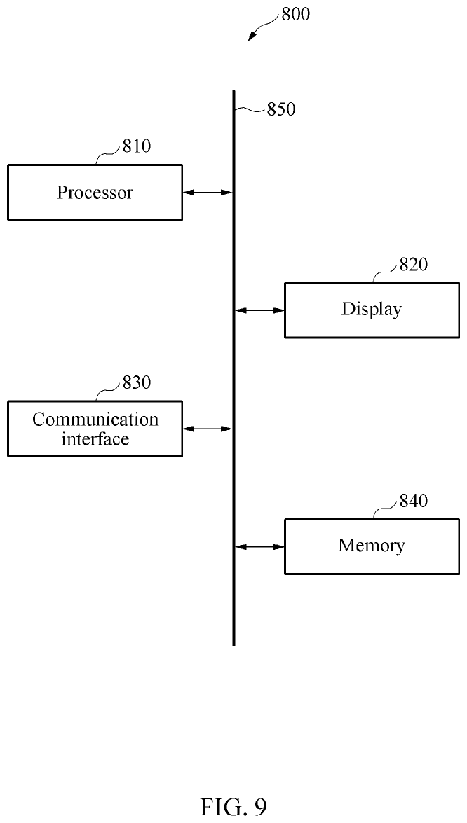

FIG. 9 is a diagram illustrating an electronic device according to an embodiment.

Referring to FIG. 9, an electronic device 800 may include a processor 810, a memory 840, display 820 and a communication interface 830. The electronic device 800 may correspond to a server and depending on an embodiment, may include terminals (e.g., a smartphone, PC, tablet PC, etc.).

According to an embodiment, the electronic device 800 may include a device related to the IMS. The processor 810 may perform operations of at least one method described with reference to FIGS. 1 to 8. For example, the processor 810 may store data generated while performing the above-described operations in the memory 840 or in an external database accessible from the electronic device 800.

The memory 840 may store the above-described data and data generated according to the execution of operations of the processor 810. The memory 840 may include, for example, a volatile memory or a non-volatile memory.

According to an embodiment, the electronic device 800 may be connected to an external device (e.g., a terminal or network) through the communication interface 830 and exchange data with the external device. For example, the electronic device 800 may exchange data with the external device to interact with another account through the communication interface 830.

According to an embodiment, the processor 810 may execute a program stored in the memory 840 and control the electronic device 800. Program code to be executed by the processor 810 may be stored in the memory 840.

The examples described herein may be implemented using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is singular; however, one of ordinary skill in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or one or more combinations thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored in a non-transitory computer-readable recording medium.

The methods according to the examples may be recorded in non-transitory computer-readable media including program instructions to implement various operations of the examples. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

The above-described hardware devices may be configured to act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operating a terminal to interact with another account through a profile view of an account, the method comprising:
determining a profile item applicable to the profile view for the account based on an input received by the terminal, wherein the profile item comprises at least one of a first item for at least one touch input-based interaction or a second item for slider input-based interaction, and a coordinate indicating a position where the profile item is provided on the profile view;
displaying the profile item on a screen of the terminal based on the determined profile item and the determined coordinate;
receiving an input related to the profile item; and
displaying a visual effect corresponding to the input on the screen.

2. The method of claim 1, wherein the profile item further comprises at least one of a third item indicating a number of times the first item is touched by another account or a fourth item indicating a number of views of a profile.

3. The method of claim 1, wherein the first item comprises an emoticon indicating emotion.

4. The method of claim 1, further comprising:
when receiving a plurality of consecutive touch inputs at the coordinate at which the first item is provided, increasing a number of times the first item is touched and displaying the visual effect corresponding to the plurality of consecutive touch inputs on the screen.

5. The method of claim 4, wherein the visual effect comprises an effect in which at least one emoticon in the first item is displayed on the screen.

6. The method of claim 1, further comprising:
displaying an emoticon in the first item on at least one coordinate of the profile view when receiving the touch input at the coordinate at which the first item is provided.

7. The method of claim 6, wherein a size of the emoticon displayed on the at least one coordinate is determined based on a selected first reference,
wherein the at least one coordinate is determined based on a selected second reference.

8. The method of claim 1, further comprising:
moving an emoticon from a first coordinate to a second coordinate that is different from the first coordinate of the profile view when receiving the touch input corresponding to the first item.

9. The method of claim 8, wherein the first coordinate is positioned above the second coordinate in a vertical direction, x-axis coordinates of the first coordinate and the second coordinate are the same, and the second coordinate is comprised in an area where a profile image is displayed on the profile view.

10. The method of claim 8, wherein the moving of the emoticon from the first coordinate to the second coordinate that is different from the first coordinate comprises moving the emoticon from the first coordinate to the second coordinate while changing the emoticon.

11. The method of claim 1, wherein the second item comprises at least one of text, a slider bar, a slider pointer capable of receiving a drag input, an image displayed on the slider pointer, or an emoticon displayed on the slider pointer.

12. The method of claim 1, further comprising:
when receiving a slider input from the coordinate at which the second item is provided, displaying the visual effect corresponding to the slider input on the screen.

13. The method of claim 12, wherein the visual effect comprises an effect in which an emoticon is displayed at a selected coordinate on the screen.

14. The method of claim 13, wherein the selected coordinate is a coordinate determined to be displayed in a middle of an x-axis of the screen and a middle of a y-axis of the screen on which the profile view is displayed.

15. The method of claim 12, further comprising:
when the slider input is an input moving in a first direction, displaying an emoticon corresponding to the first direction at a selected coordinate on the screen; and
maintaining a horizontal width of a slider bar and increasing a vertical width of a slider bar as a slider pointer moves in the first direction.

16. The method of claim 12, further comprising:
determining a size of an emoticon displayed on the screen based on a degree of movement of a slider pointer.

17. The method of claim 12, further comprising:
displaying profile images of the other account on a slider pointer when the slider input ends.

18. The method of claim 1, further comprising:
when a plurality of profiles corresponding to the account exists, creating profile views corresponding to each of the plurality of profiles; and
determining at least one profile item to be displayed for each of the profile views based on an input signal received from the account.

19. A non-transitory computer-readable storage medium storing instructions that, when executed by a processor, cause the processor to perform the method of claim 1.

20. A terminal configured to:
determine a profile item applicable to a profile view for an account based on an input received by the terminal, wherein the profile item comprises at least one of a first item for at least one touch input-based interaction or a second item for slider input-based interaction, and a coordinate indicating a position where the profile item is provided on the profile view;
display the profile item on a screen of the terminal based on the determined profile item and the determined coordinate;
receive an input related to the profile item; and
display a visual effect corresponding to the input on the screen.
